(19) United States
(12) Patent Application Publication
(10) Pub. No.: US 2005/0082716 A1
(43) Pub. Date: Apr. 21, 2005

(54) Resin infusion potting

(76) Inventors: Kevin J. Barefield, Tallahassee, FL (US); Richard V. Campbell, Tallahassee, FL (US)

Correspondence Address: Pennington, Moore, Wilkinson, Bell & Dunbar, P.A., Post Office Box 10095, Tallahassee, FL, 32302-2095, US

(21) Appl. No.: 10/730,564

(22) Filed: Dec. 8, 2003

Related U.S. Application Data
(60) Provisional application No. 60/431,379, filed on Dec. 6, 2002.

(51) Int. Cl. B29C 45/14

(52) U.S. Cl. 264/261; 264/263; 264/571; 264/328.1

(57) ABSTRACT

A process for forcibly infusing liquid potting compound into the exposed strands of a cable prior to forming a termination. The process uses a mold that encloses the exposed strands. Potting compound is then pumped into the mold, where it runs around and through the exposed strands. A second venting passage is preferably employed, so that the liquid potting compound flows through the mold without trapping any air pockets.

### BACKGROUND OF THE INVENTION

1. Field of the Invention

This invention relates to the field of cables and ropes. More specifically, the invention comprises a process for thoroughly infusing liquid potting compound into the strands of a rope or cable prior to affixing an anchor or for other uses.

2. Description of the Related Art

Devices for mounting a termination on the end of a rope or cable are disclosed in detail in copending U.S. application Ser. No. 60/404973 to Campbell, which is incorporated herein by reference. Throughout this disclosure, the term “strand” will be used to describe the constituents of synthetic cables, natural-fiber cables, and ropes. Although synthetic cables are used for the illustrations, the reader should understand that the methods and devices disclosed are equally applicable to any type of stranded cable.

It is often useful to affix a piece of hardware to the end of a cable. Examples of hardware would be threaded fasteners, hooks, and eyes. Such hardware will be generically referred to as an “anchor.” Anchors typically have an expanding internal passage or some type of interlocking features, such as ridges. The strands proximate the end of a cable are wetted with liquid potting compound. The wetted strands are then placed within the internal passage of the anchor. The potting compound then hardens to form a solid, thereby locking a length of strands into the anchor. The anchor, along with the contained strands and solid potting compound will be referred to as a “termination.”

Those skilled in the art will know that the term “potting compound” generally refers to any liquid which can be transformed into a solid (such as by air-drying, cooling, reacting with a catalyst, etc.). Examples include thermoplastics, molten metals, thermosets, and reactive compounds (such as two-part epoxies).

Two methods of infusing liquid potting compound into the strands of a cable are in common use. These are: (1) Pulling an anchor into its final position around the exposed strands and pouring the liquid potting compound into an open end of the anchor; or (2) Infusing the exposed strands with liquid potting compound, then pulling the anchor into its final position (The infusion is typically accomplished via painting on the liquid potting compound or dipping the exposed strands into a vat of liquid potting compound).

Under either approach, the potting compound may fail to fully infuse the strands. Moreover, both approaches must generally be performed manually, resulting in drastic variations from termination to termination.

FIG. 1 shows four cables 10 with exposed strands in varying configurations. The far left example shows core strands 12 exposed and ready for potting in an undisturbed state. Proceeding to the right, the next example shows the exposed strands being compressed to form fanned strands 14. The next example shows the exposed strands being splayed to form conical strands 16. The far right example shows the strands being splayed apart further to form radially fanned strands 44. All these examples, as well as others, may be employed prior to infusing the exposed strands with liquid potting resin.

### BRIEF SUMMARY OF THE PRESENT INVENTION

The present invention comprises a process for forcibly infusing liquid potting compound into the exposed strands of a cable prior to forming a termination. The process uses a mold that encloses the exposed strands. Potting compound is then pumped into the mold, where it runs around and through the exposed strands. A second venting passage is preferably employed, so that the liquid potting compound flows through the mold without trapping any air pockets. After infusion and before the liquid potting compound hardens, the mold is opened.

### BRIEF DESCRIPTION OF THE SEVERAL VIEWS OF THE DRAWINGS

FIG. 1 is an isomeric view, showing various cable strand configurations.

FIG. 2 is an isometric view, showing the operation of a mold.

FIG. 3 is an isometric view, showing internal passages within the mold.

FIG. 4 is an isometric section view, showing the mold base.

FIG. 5 is an isometric view, showing the installation of an anchor.

FIG. 6 is an isometric view, showing the installation of an anchor.

FIG. 7 is an isometric view, showing the mold on an assembly line.

FIG. 8 is an isometric view, showing a cable clamped within a mold.

FIG. 9 is an isometric view, showing an injector.

FIG. 9B is an isometric view, showing an alternate injector.

FIG. 10 is an isometric section view, showing the operation of an injector.

FIG. 11 is an isometric section view, showing the operation of an injector.

### REFERENCE NUMERALS IN THE DRAWINGS

| | | | |
|---|---|---|---|
| 10 | cable | 12 | core strands |
| 14 | fanned strands | 16 | conical strands |
| 18 | anchor | 20 | upper mold portion |
| 22 | mold base | 24 | strand cavity |
| 26 | separator | 28 | cable cavity |
| 30 | strand cavity | 32 | infeed runner |
| 34 | liquid coupling | 36 | liquid vent |
| 38 | vent coupling | 40 | infused strands |
| 42 | anchor fork | 44 | radially fanned strands |
| 46 | injector | 48 | needle |
| 50 | injection orifice | 52 | vent |
| 54 | dry strands | | |

### DETAILED DESCRIPTION OF THE INVENTION

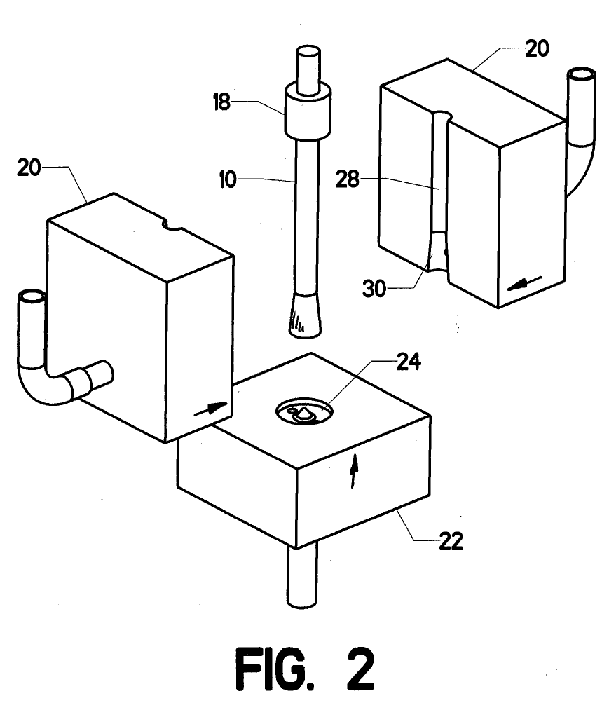

FIG. 2 shows one embodiment of the present invention. Anchor 18 is placed on cable 10 and pulled away from the exposed end strands to the position shown. Cable 10 is then positioned between the upper mold portions 20 (In the example shown, two mold portions are used. The upper portion of the mold can also be split into three or more portions). Each upper mold portion 20 preferably includes a cable cavity 28 and a strand cavity 30. Mold base 22 lies beneath cable 10. The two upper mold portions 20 clamp securely together, as indicated by the arrows. This action results in cable 10 being held tightly within the internal passages in the two upper mold portions.

Mold base 22 then moves upward to seal off the bottom of cable 10. Those skilled in the art will realize that the type of mold shown is but one among many. The mold could split in other ways, move together in different ways, etc.

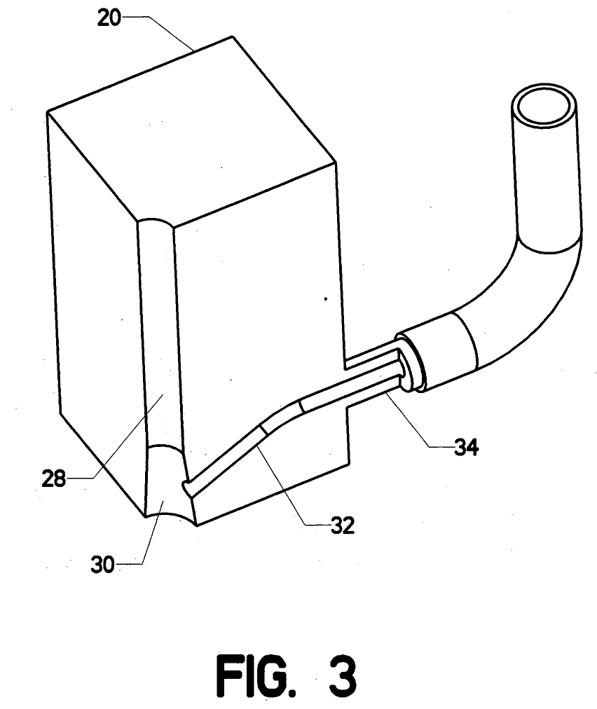

Once the mold closes, cable 10 is held securely within the internal passages. FIG. 3 is a sectional view of one of the two upper mold portions 20. The reader will observe that infeed runner 32 connects liquid coupling 34 with strand cavity 30. When clamped in place, preferably pressurized liquid potting compound is forced through infeed runner 32 where it emerges in and around the exposed strands of cable 10. Cable cavity 28 is clamped securely around the rest of cable 10, thereby preventing the liquid potting compound from diffusing upward beyond the exposed end strands. As an alternative, a fairly loose fit can be provided around cable 10 so that entrapped air can vent past cable 10. The second upper molding portion can be equipped with a corresponding infeed runner. Additional infeed runners could also be provided in the mold base. An infeed runner could be placed at virtually any location and in any orientation within strand cavity 30.

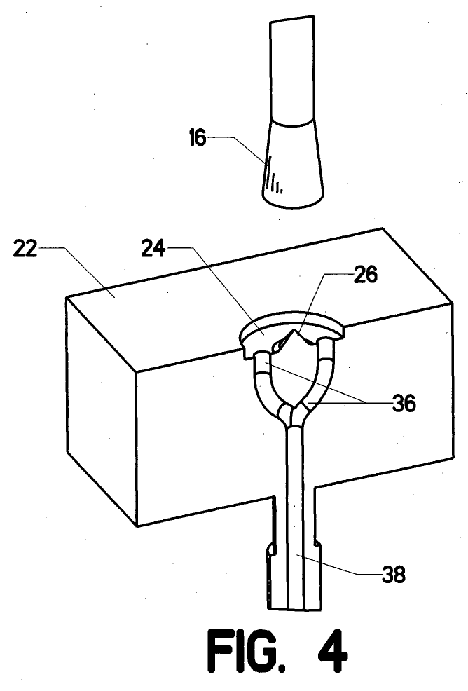

FIG. 4 is an isometric section view of mold base 22. Its upper surface opens into strand cavity 24 (A flat upper surface having no recess can also be used). A conically shaped separator 26 may be provided in the middle in order to splay the exposed strands of the cable when mold base 22 is moved up into position. Mold base 22 is preferably equipped with one or more liquid vents 36. These connect to vent coupling 38. In operation, the mold parts are clamped together to form the enclosed strand cavity 30. Liquid potting compound is then forced under pressure into the mold through infeed runners 32. Liquid vents 36 allow air within the mold cavity to escape. Eventually, liquid potting compound completely fills the cavity and flows out through liquid vents 36. A vacuum may be applied to vent coupling 38 in order to promote faster flow or more complete liquid potting compound infusion.

As an alternative, the infeed runners and liquid vents can be reversed so that the liquid potting compound flows from the bottom to the top. Vacuum and pressure can also be used interchangeably to create the desired flow. Although the runners and vents have been shown as circular, those skilled in the art will know that they could also be made with an oval cross section, a square cross section, or any other desired shape.

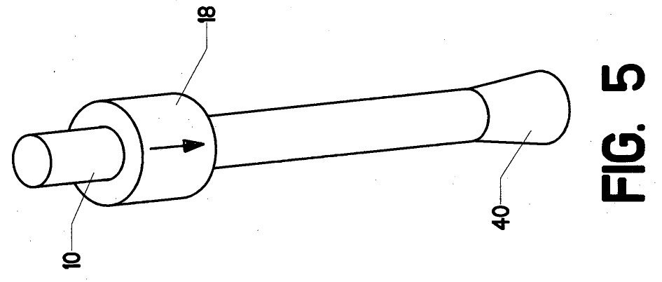

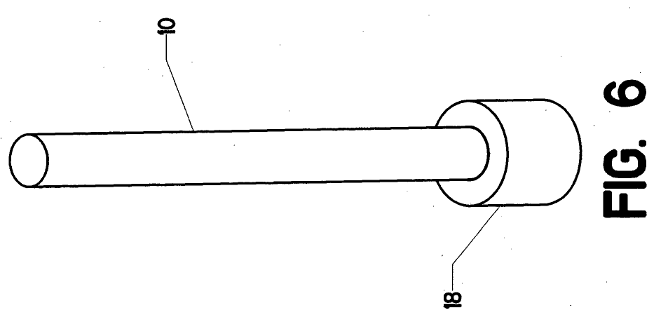

FIG. 5 shows cable 10 after its end strands have been infused with liquid potting compound within the mold. The end strands are now denoted as infused strands 40. Anchor 18 is then moved down in the direction shown until it encloses the infused end strands (or otherwise mechanically interlocks). Anchor 18 is shown in its final position in FIG. 6. It remains in this position while the liquid potting compound hardens into a solid, thereby forming a completed termination. As an alternative, anchor 18 can be slid into position from the opposite end of the cable after the liquid potting compound is applied.

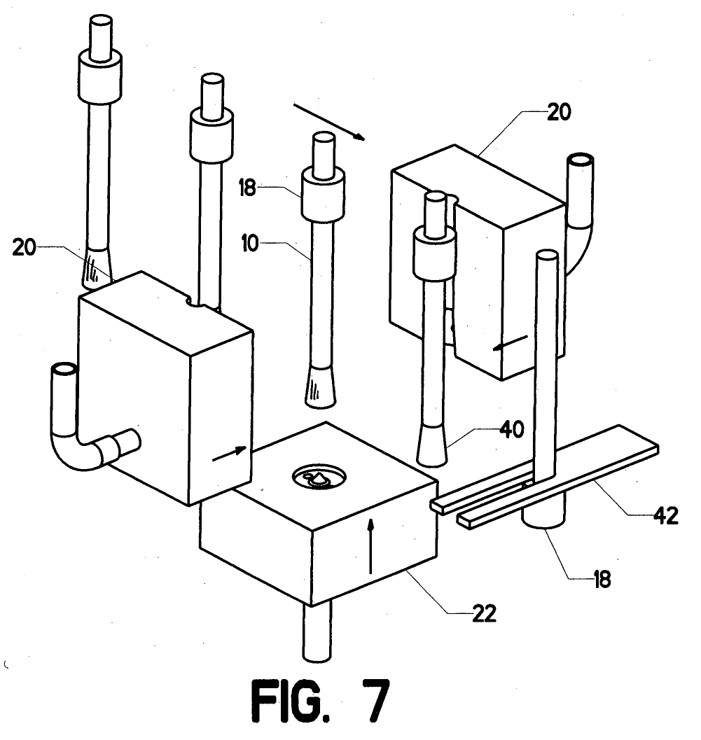

FIG. 7 shows the application of the devices and processes disclosed to an assembly line. A series of cables 10—with anchors 18 in an appropriate position, are sequentially fed along the line in the direction indicated by the arrow. The middle cable 10 is set to be clamped within the mold components. Its exposed end strands will then be infused with liquid potting compound. The cable 10 immediately to the right of the middle cable 10 has just exited the mold. Its end strands have been infused with liquid potting compound. They are thus denoted as infused strands 40.

As cable 10 moves further down the line, anchor fork 42 (or other suitable devices, whether automatic or manual), may be employed to pull anchor 18 into the appropriate position before the liquid potting compound hardens. Similar devices can be employed to retain the anchors in the appropriate positions throughout the process.

The same process can be applied where a mold is substituted for anchor 18. In other words, a mold can be pulled in place over the strands while they are allowed to set. This mold can then be removed and the strands placed in a separate anchor.

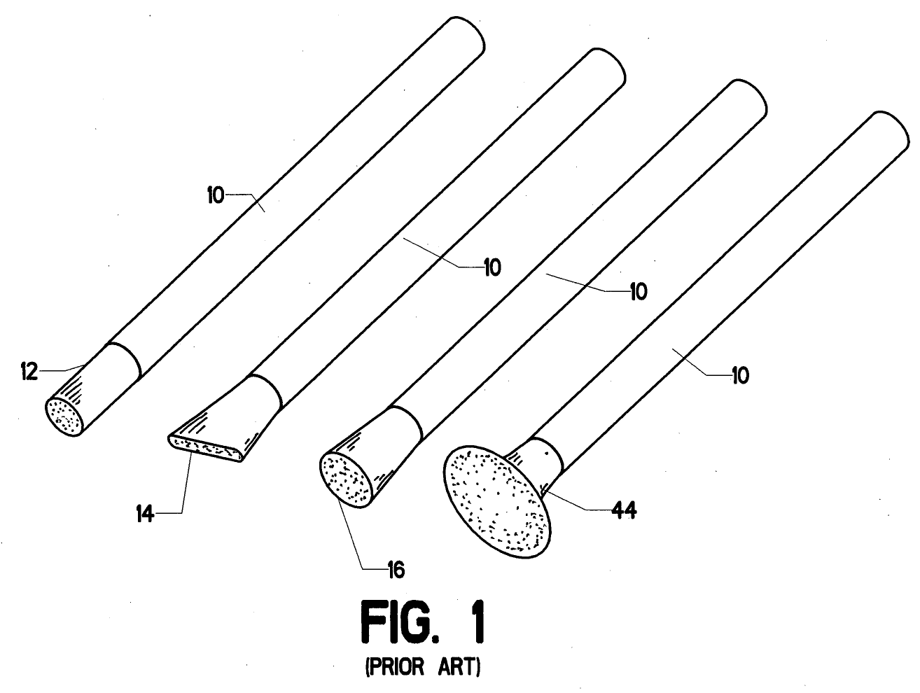

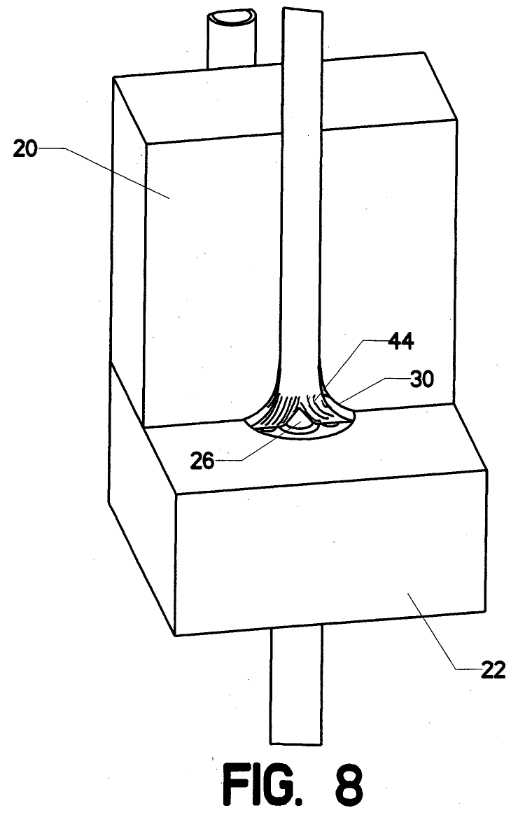

Those skilled in the art will realize that the internal cavities within the mold components, as well as the infeed runners and vents, can be made in virtually any shape. Multi-cavity molds can also be used to increase the feed rates. Returning to FIG. 1, the reader will appreciate that the mold can be configured to clamp the fibers in any one of the four configurations shown (as well as others). As an example, FIG. 8 shows a mold having a strand cavity 30 shaped to deform the strands into radially fanned strands 44 (The cable is shown sectioned to aid visualization). A separator 26 is also used.

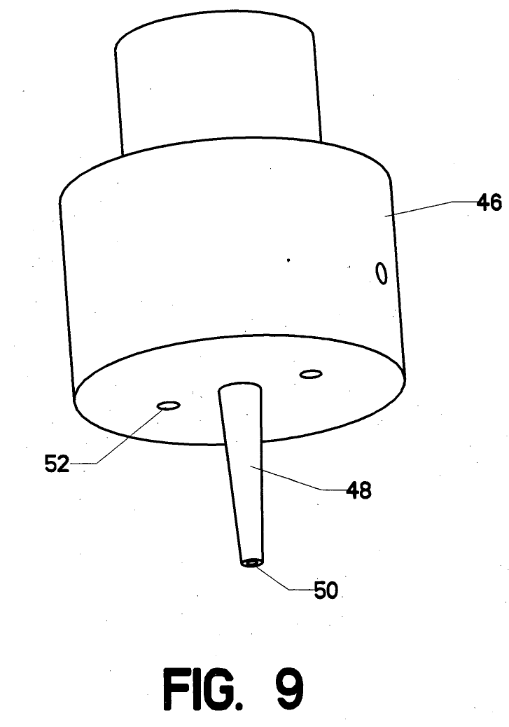

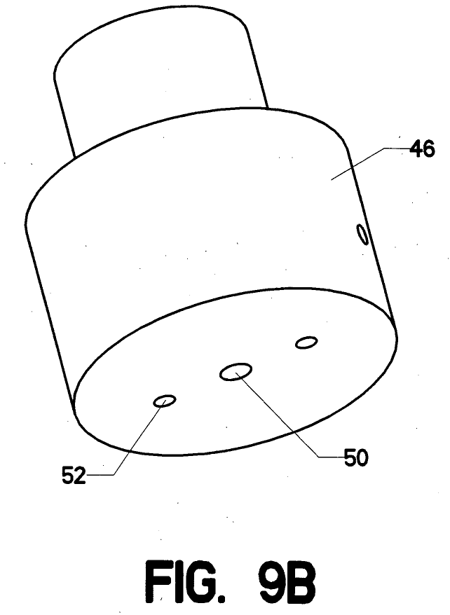

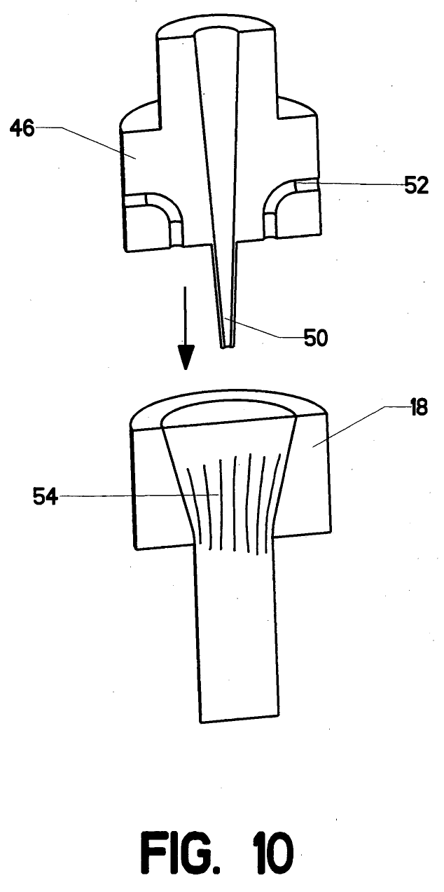

The injection process can even be modified to infuse the liquid potting compound from the center of the exposed strands outward. FIG. 9 shows injector 46. Needle 48 extends from its lower surface. Injection orifice 50 passes through needle 48 (The orifice can assume a variety of shapes). The lower surface also opens into a pair of vents 52. FIG. 10 shows injector 46 in a section view. Injection orifice 50 is connected to a supply of liquid potting compound (not shown). Vents 52 can be vented to the surrounding air. In operation, a mold is placed around the dry exposed strands on the end of a cable. For the example shown, an anchor 18 is actually used as the mold (Split molds such as shown previously could also be used). The anchor has an expanding internal passage which serves as a strand cavity. It also has an open end. Injector 46 is moved toward the exposed strands as indicated.

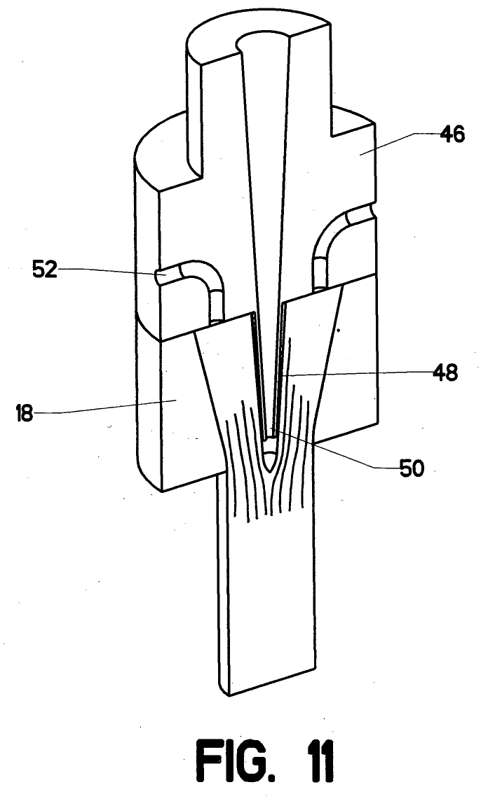

FIG. 11 shows injector 46 mated to anchor 18. The lower surface of injector 46 is actually pressed against the upper surface of anchor 18 to form a sealing surface. Needle 48 protrudes down into the exposed strands. Liquid potting compound is then infused through injection orifice 50. It flows out through the strands toward the two vents 52, thereby completely infusing the strands within the anchor's internal passage. Once the infusion is completed, injector 46 is withdrawn. The liquid potting compound then hardens to complete the termination.

Those skilled in the art will realize that injector 46 can take many forms, including breaking the injector into two or more pieces (like a mold). Needle 48 is optional. The injection could be accomplished via forcing the liquid potting compound through a simple hole. Such an alternate embodiment is shown in FIG. 9B. Likewise, the seal between injector 46 and anchor 18 can be acheived using many methods, including an O-ring or interlocking threads. With the anchor itself forming the mold, it may be advisable to add infeed runners or vents to the anchor. These features could take many shapes.

As stated previously, a split mold can be used in the place of anchor 18. In such a case, the anchor would be added after the infusion process is complete.

Throughout the preceding disclosure, terms referring to the orientation of the parts have been used (“upper”, “lower”, etc.). Those skilled in the art will realize that the orientation of the components has no significant impact on the operation of the devices. These terms referred only to the orientations shown in the views, and should not be taken as limiting the scope of the invention.

Although the preceding description contains significant detail, it should not be construed as limiting the scope of the invention but rather as providing illustrations of the preferred embodiments of the invention.

1. A method for infusing a region of strands in a cable with liquid potting compound, comprising:
a. exposing said region of strands in said cable;
b. providing a mold including
i. a strand cavity;
ii. an infeed runner for carrying said liquid potting compound, wherein said infeed runner leads into said strand cavity;
c. placing said region of strands within said strand cavity within said mold; and
d. injecting said liquid potting compound into said strand cavity through said infeed runner, so that said liquid potting compound infuses throughout said region of strands.

2. A method as recited in claim 1, wherein said step of exposing said region of strands comprises splaying said region of strands into a fan.

3. A method as recited in claim 1, wherein said step of exposing said region of strands comprises splaying said region of strands into a cone.

4. A method as recited in claim 1, wherein said step of exposing said region of strands comprises splaying said region of strands into a radial fan.

5. A method as recited in claim 1, comprising the additional step of providing said mold with a separator positioned to splay said region of strands apart when said region of strands is placed within said strand cavity.

6. A method as recited in claim 1, comprising the additional step of providing said mold with a liquid vent connected to said strand cavity.

7. A method as recited in claim 6, comprising the additional step of applying a vacuum to said liquid vent.

8. A method for infusing a region of strands in a cable with liquid potting compound, comprising:
a. exposing said region of strands in said cable;
b. providing a mold including a strand cavity having an open end;
c. placing said region of strands within said strand cavity within said mold;
d. providing an injector, including
i. a sealing surface;
ii. a needle, extending from said sealing surface, having a first end proximate said sealing surface and a second end distal to said sealing surface;
iii. an injection orifice proximate said second end of said needle;
e. clamping said injector against said mold so that said needle protrudes into said region of strands and said sealing surface seals said open end of said strand cavity; and
f. injecting said liquid potting compound into said strand cavity through said injection orifice, so that said liquid potting compound infuses throughout said region of strands.

9. A method as recited in claim 8, further comprising the additional step of providing said injector with a vent.

10. A method as recited in claim 8, wherein said mold is an anchor and said strand cavity is an internal passage within said anchor.

11. A method for attaching an anchor having an internal passage and an open end to a region of strands on an end of a cable, comprising:
a. exposing said region of strands in said cable;
b. placing said region of strands within said internal passage of said anchor;
c. providing an injector, including
i. a sealing surface;
ii. a needle, extending from said sealing surface, having a first end proximate said sealing surface and a second end distal to said sealing surface;
iii. an injection orifice proximate said second end of said needle;
d. clamping said injector against said open end of said anchor so that said needle protrudes into said region of strands and said sealing surface seals said open end of said anchor;
e. injecting said liquid potting compound into said strand cavity through said injection orifice, so that said liquid potting compound infuses throughout said region of strands; and
f. allowing said liquid potting compound to harden into a solid, thereby locking said region of strands within said anchor.

12. A method as recited in claim 11, further comprising the additional step of providing said injector with a vent.

13. A method for attaching an anchor having an internal passage and an open end to a region of strands on an end of a cable, comprising:
a. exposing said region of strands in said cable;
b. providing a mold including
i. a strand cavity;
ii. an infeed runner for carrying said liquid potting compound, wherein said infeed runner leads into said strand cavity;
c. placing said region of strands within said strand cavity within said mold;
d. injecting said liquid potting compound into said strand cavity through said infeed runner, so that said liquid potting compound infuses throughout said region of strands;
e. removing said region of strands from said mold;
f. placing said anchor proximate said region of strands so that said region of strands lies within said internal passage; and
g. allowing said liquid potting compound to harden into a solid, thereby locking said region of strands within said anchor.

14. A method as recited in claim 13, wherein said step of exposing said region of strands comprises splaying said region of strands into a fan.

15. A method as recited in claim 13, wherein said step of exposing said region of strands comprises splaying said region of strands into a cone.

16. A method as recited in claim 13, wherein said step of exposing said region of strands comprises splaying said region of strands into a radial fan.

17. A method as recited in claim 13, comprising the additional step of providing said mold with a separator positioned to splay said region of strands apart when said region of strands is placed within said strand cavity.

18. A method as recited in claim 13, comprising the additional step of providing said mold with a liquid vent connected to said strand cavity.

19. A method as recited in claim 18, comprising the additional step of applying a vacuum to said liquid vent.

20. A method for infusing a region of strands in a cable with liquid potting compound, comprising:
a. exposing said region of strands in said cable;
b. providing a mold including a strand cavity having an open end;
c. placing said region of strands within said strand cavity within said mold;
d. providing an injector, including
i. a sealing surface;
ii. an injection orifice in said sealing surface;
e. clamping said injector against said mold so that said injection orifice is directed toward said region of strands and said sealing surface seals said open end of said strand cavity; and
f. injecting said liquid potting compound into said strand cavity through said injection orifice, so that said liquid potting compound infuses throughout said region of strands.

21. A method as recited in claim 20, further comprising the additional step of providing said injector with a vent.

22. A method as recited in claim 21, wherein said mold is an anchor and said strand cavity is an internal passage within said anchor.
